(19) United States
(12) Patent Application Publication
(10) Pub. No.: US 2006/0195327 A1
(43) Pub. Date: Aug. 31, 2006

(54) Method and system for reporting and processing information relating to railroad assets

(76) Inventors: Ajith Kuttannair Kumar, Erie, PA (US); Christopher Wade McNally, Girard, PA (US); Harold Stevenson Hostettler, Edinboro, PA (US); Patricia S. Lacy, Edinboro, PA (US); Glenn Robert Shaffer, Erie, PA (US); Wolfgang Daum, Erie, PA (US); Bradley Charles Hendrickson, Erie, PA (US); Daniel Malachi Ballesty, Wattsburg, PA (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/057,815

(22) Filed: Feb. 14, 2005

(51) Int. Cl. G06Q 99/00

(52) U.S. Cl. 705/1

(57) ABSTRACT

Method, system, and computer program product are provided for reporting and processing information relating to railroad assets to user entities that form part of a railroad transportation network. The entities may comprise a plurality of entity groups performing distinct functions relative to the railroad assets, such as forming, operating, maintaining and/or servicing the assets of the railroad transportation network.

### BACKGROUND OF THE INVENTION

The present invention is generally related to railroad assets, and, more particularly, to a method and system for reporting and processing information relating to railroad assets to user entities that form part of a railroad transportation network.

Railroad assets, such as railroad locomotives, railcars, wayside equipment, rail tracks, etc., may comprise high-value and resource-intensive assets that can function over large geographical areas and may require the coordinated involvement of various groups of user entities to ensure reliable and cost-effective operation. For example, modern railroad locomotives typically include multiple operating systems including sophisticated computerized controls responsive to a large number of input variables. A typical electromotive railroad locomotive is propelled by a plurality of AC or DC traction motors connected to respective drive axles, with the electrical energy for the motors being supplied by an on-board generator powered by a diesel engine. Each of these systems needs to be appropriately operated and serviced based on timely and reliable information in order to consistently achieve cost effective and reliable operation of the railroad asset and meet governmental regulations that may apply to the railroad asset.

Some of the logistical complexities associated with the management of railroad assets have posed challenges regarding cost-efficient, coordinated, and timely delivery of information in connection with the railroad assets that make up a railroad transportation network. Accordingly, it would be desirable to provide systems and techniques that would allow for a more focused and timely delivery of information regarding the railroad assets. It is also desirable to provide systems and techniques that facilitate implementing operational and/or logistical decisions in a coordinated fashion, and further facilitate the performance of decisions and actions for conducting operations based on user-friendly, integrated and focused information regarding the actual status of a railroad asset, such as a locomotive and associated support structure.

### BRIEF DESCRIPTION OF THE DRAWINGS

The features and advantages of the present invention will become apparent from the following detailed description of the invention when read with the accompanying drawings in which:

FIG. 1 is a block diagram representation of an exemplary embodiment of a computerized system for processing and reporting information relating to railroad assets to various user entities.

FIG. 2 illustrates a number of exemplary messages that may be generated by the system of FIG. 1 for reporting information relating to the railroad assets, wherein such messages are automatically customized, e.g., contents and/or formatting, to meet the informational needs of the various user entities.

FIG. 3 is flow diagram illustrating an exemplary utilization of externally derived diagnostics knowledge data that may be used for reconfiguring a diagnostics output to be reported to a user entity regarding the condition of a railroad asset.

FIG. 4 is block diagram illustrating exemplary calculating modules that may be used for generating a respective parameter indicative of a time-varying health condition for a respective piece of equipment onboard a locomotive.

FIG. 5 is a block diagram illustrating an exemplary calculating module that may be used for reporting locomotive availability to a user entity, wherein the calculation may be based on interactions between systems onboard a locomotive.

### DETAILED DESCRIPTION OF THE INVENTION

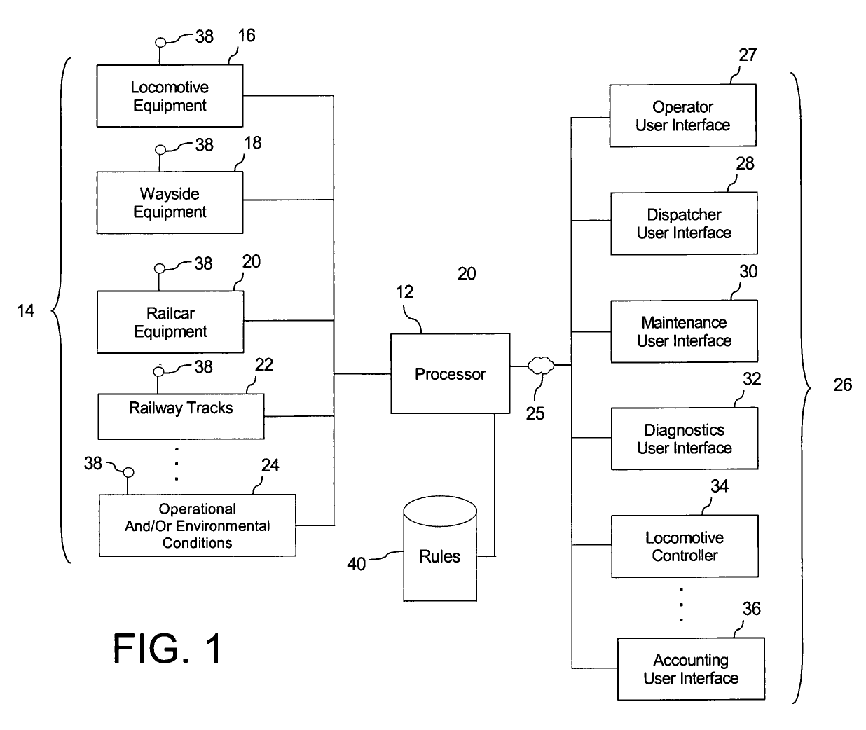

FIG. 1 is a schematic representation of an exemplary embodiment of a computerized system 10 including a processor 12 for reporting and processing information relating to railroad assets 14, such as locomotive equipment 16, wayside equipment 18, railcar equipment 20, railway tracks 22 (including structures, such as bridges, tunnels, etc), and operational and/or environmental conditions 24 associated with the railroad assets. The information relating to the railroad assets may be communicated by any suitable communication link 25, e.g., wired, wireless, radio, telephone, satellite, modem, internet, local area network, wide area network, etc., to user entities 26 that form part of a railroad transportation network. The entities 26 may be composed of a plurality of entity groups that perform distinct functions relative to the railroad assets, such as forming, operating, maintaining and/or servicing the assets of the railroad transportation network. Examples of devices for the entities 26 that may be recipient of information related to the railroad assets may be an operator user interface 27, such as may be used for communicating information to a locomotive operator, a dispatcher user interface 28, such as may be used for communicating information to a dispatcher, a maintenance user interface 30, such as may be used for communicating information to service personnel, a diagnostics user interface 32, such as may be used for communicating information to personnel responsible for running diagnostic services, a locomotive controller 34, such as may be used for controlling various equipment onboard a locomotive, and a finance accounting user interface 36, such as may be used for communicating asset utilization information to personnel responsible for managing financial operations that affect the railroad transportation network. Thus, it will be appreciated that such devices may be onboard a locomotive, or may be remote relative to the locomotive or, stated more broadly, the recipients of the information may be remote relative to any particular railroad asset or could be part of a railroad asset, such as the locomotive controller.

The system allows identifying at least two user entity groups having a distinct function relative to the railroad assets. For example, a diagnostics engineer will require a different level of information regarding the condition of a railroad asset than the locomotive operator or service personnel. A suite of monitors 38 allows monitoring one or more conditions associated with a railroad asset, such as the condition of locomotive equipment, the condition of the wayside equipment, the operational and/or environmental conditions associated with the railroad assets. The suite of monitors allows generating data indicative of the condition of the railroad asset, and such data is processed by processor 12, as described in greater detail below.

A storage device 40 may be used for storing rules for associating with each identified entity group a unique set of informational characteristics of interest to each identified entity group regarding the condition of the railroad asset. The unique set of informational characteristics, such as formatting and/or content, to be used for reporting asset status information may be based on the distinct functions performed by any given user entity group.

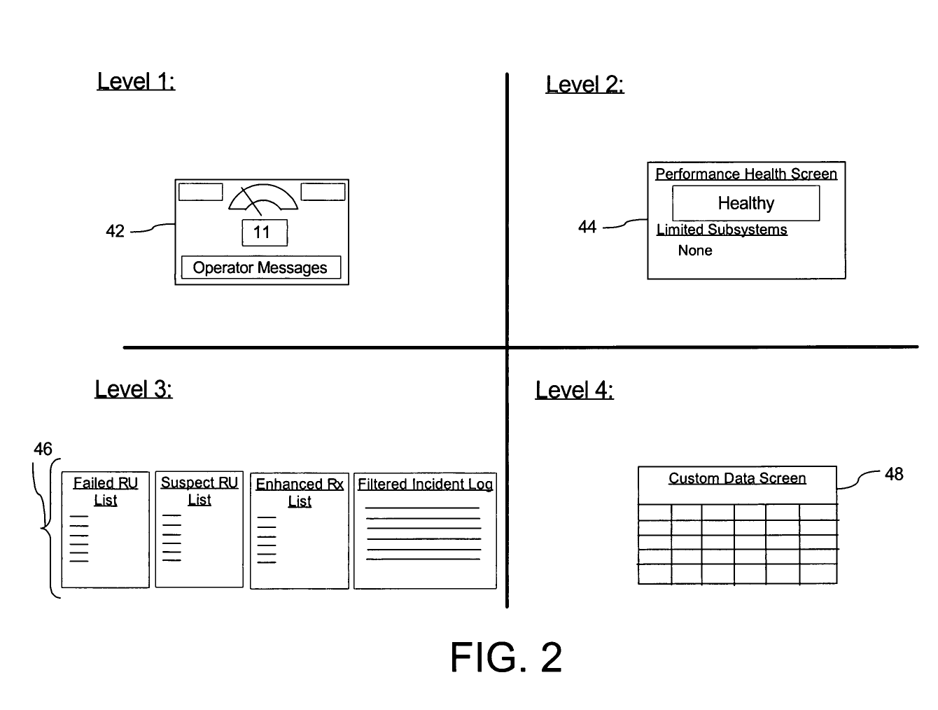

Processor 12 may be configured to process the data regarding the railroad assets relative to the rules stored in storage device 40 to generate a message with the unique set of informational characteristics for each respective group regarding the condition associated with the railroad asset. For example, as illustrated in FIG. 2, a message 42 identified with a level 1 type of informational characteristics may provide succinct information to the locomotive operator, such as whether or not the locomotive is ready to perform a railroad mission. A message 44 identified with a level 2 type of informational characteristics may be tailored to meet the needs of a dispatcher, such as whether any given locomotive can perform some missions subject to certain operational restrictions. This level of information would be helpful to the dispatcher since that locomotive may not be capable of performing every mission that the locomotive can normally perform but may be capable of performing, for example, a light haul mission over relatively flat terrain. It will be appreciated that such level of detail is necessary for a dispatcher but could be burdensome and/or distracting to the locomotive operator since the operator may just want to know that, once a mission has been allocated for the locomotive, the locomotive is ready to go.

A message 46 identified with a level 3 type of informational characteristics may be tailored to meet the needs of service personnel, such as a list of failed components, list of previous maintenance actions, list of possible repairs, etc. A message 48 identified with a level 4 type of informational characteristics may be customized to meet the needs of a diagnostics engineer, such as a comprehensive level of detail that would allow a substantial understanding regarding prevailing conditions or fault relationships at or near the time of the occurrence of a given malfunction. Communication link 25 (FIG. 1) allows communicating the generated messages to the respective entity groups. It will thus be appreciated that aspects of the present invention allow for communicating and automatically tailoring data for each user entity group based on the distinct needs of such entity groups. Thus, the same underlying data regarding one or more conditions that may be affecting a railroad asset can generate messages with different informational characteristics for the various user entities.

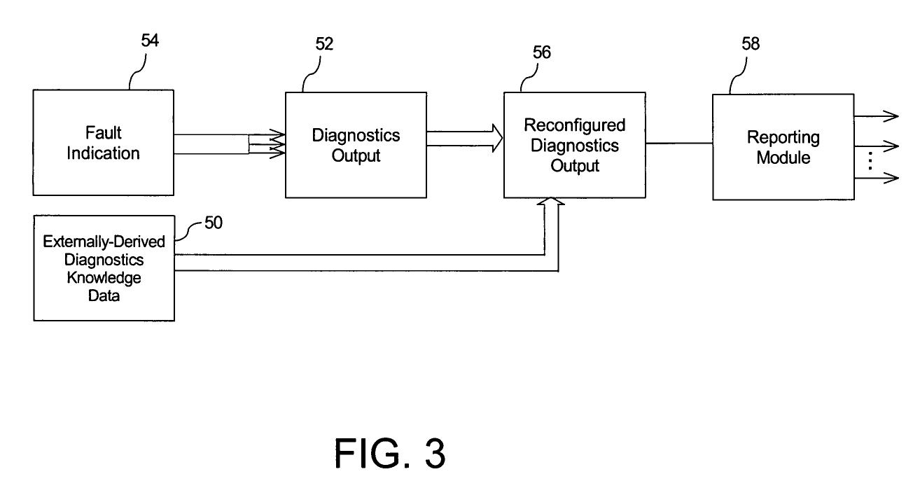

In one exemplary embodiment, as illustrated in the conceptual flow diagram representation of FIG. 3, externally derived diagnostics knowledge data 50 may be used for reconfiguring a diagnostics output 52. For example, the logging of a fault indication 54 may normally trigger a message indicating that there is a particular speed sensor malfunction. However, the externally derived diagnostics knowledge data 50, such as may be obtained from a plurality of locomotives that belong to a class similarly affected as the locomotive presently experiencing this type of incident, may indicate that such locomotives have received a defective batch of speed sensor I/O (Input/Output) cards, and consequently the occurrence of fault indication 54 in this locomotive when processed together with the externally derived diagnostics knowledge data 50 would not trigger a diagnostics malfunction for the speed sensor but would generate a reconfigured diagnostics output 56 that would indicate an I/O card malfunction in lieu of a speed sensor malfunction. A message with the reconfigured diagnostics output would be reported by way of reporting module 58 to the appropriate user entity. The foregoing constitutes an example where the contents of the message to be reported regarding a given condition of a railroad asset is actually reconfigured based on outside knowledge relevant to the given condition. In one exemplary embodiment, the externally derived diagnostics knowledge data 50 may be gathered by a diagnostics center operated by the assignee of the present invention in Erie, Pa. It will be appreciated that the uploading of the externally derived diagnostics knowledge data to a given locomotive may be performed by any suitable communication link, such as uploading via wired or wireless communication, uploading via a data transfer device, e.g., a compact disk or any other suitable storage device.

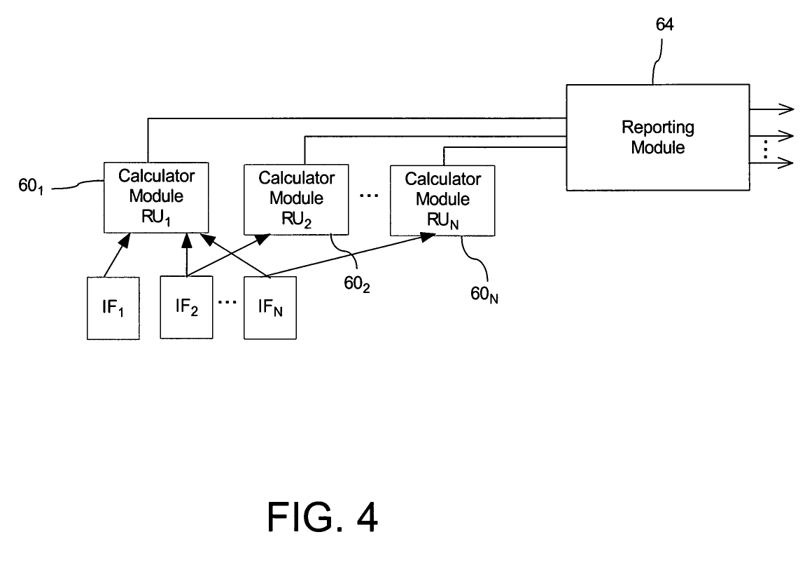

In accordance with additional aspects of the present invention, illustrated in block diagram representation in FIG. 4, one or more calculating modules 60₁, 60₂ . . . 60ₙ may be used for calculating a respective parameter indicative of a time-varying health condition for a respective piece of equipment that may be onboard a locomotive, such as replaceable units RU₁, RU₂ . . . RUₙ. Each calculating module may be responsive to the occurrence of predefined combinations of incidents and/or faults, such as IF₁, IF₂ . . . IF_{N} to determine the value of the parameter indicative of the time-varying health condition. This is particularly advantageous over traditional techniques that tend to report any incident and/or fault in connection with an RU regardless of whether that incident and/or fault is likely to be indicative of an actual malfunction or whether the malfunction is sufficiently severe to likely result in a mission failure for the locomotive. For instance, compare a situation where the occurrence of a given incident and/or fault occurs just occasionally over a relatively long period of time to a situation where the frequency of incident faults exhibits a continuously and rapidly growing trend. This latter situation may reflect a rapidly deteriorating health condition that may need prompt reporting to service personnel for appropriate remedial action as compared to the former situation that may be of some interest to a diagnostics engineer but not necessarily to service personnel. Based on the value of the parameter indicative of the time-varying health condition relative to a health condition threshold, such as may be experimentally and/or analytically derived for a given piece of equipment, a reporting module 64 is configured to adjust the unique set of informational characteristics to be communicated to each respective entity group regarding the condition indicated by the monitored data for that piece of equipment. For example, the reporting outcome may be not to report any message to at least some of the user entities provided the parameter indicative of the time-varying health condition is above the health condition threshold for that user entity.

One may further define and store a transfer function for calculating a parameter indicative of a time-varying health condition for a respective system onboard a locomotive. The transfer function may be configured to determine the individual effect of each component that comprises the system on the parameter indicative of the time-varying health condition for that system. For example, the propulsion system of the locomotive may comprise various components, such as power rectifiers, inverter drives, bank of capacitors, regenerative dynamic braking equipment, traction motors, etc. In this case, the transfer function allows calculating a parameter indicative of the time-varying health condition for the propulsion system based, for example, on the individual effect that a given power rectifier, inverter or any other subsystem will have on the propulsion system. It will be appreciated that such transfer function may be experimentally or analytically derived. Furthermore, classical adaptive learning techniques may be used for estimating such transfer function. By way of example, a neural network processor may comprise at least one neural network estimator for generating one or more estimated transfer functions. Typically, the neural network estimator may be coupled to receive selected sensed locomotive operating parameters from various sensors, such as speed, emissions, notch level, tractive effort, etc., to generate an estimated transfer function that may be used for calculating the parameter indicative of the time-varying health condition. Furthermore, fuzzy logic techniques may be used for processing the relationships for calculating the parameter indicative of the time-varying health condition.

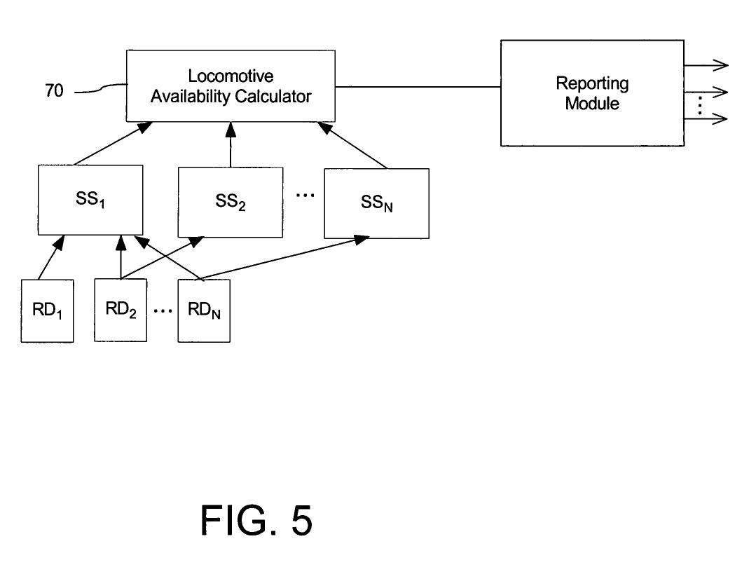

FIG. 5 is a block diagram regarding another aspect of the present invention. This embodiment provides a calculator module 70 for calculating locomotive availability. This calculation may be based on a transfer function for determining the combined effect that one or more system restrictions or derations, identified as RD₁, RD₂, . . . RD_{N}, such as may affect any of the various systems onboard the locomotive, such as systems SS₁, SS₂ . . . SS_{N}, will have on locomotive availability. This would allow configuring a message that for example may be helpful to a dispatcher. For example, depending on the type of restrictions and their combined effect, the locomotive may be declared as available for performing at least certain missions notwithstanding that one or more of the systems may be subject to certain restrictions. Conversely, depending on the overall effect to the locomotive, there may be situations when just a single restriction on a key locomotive system may be sufficient for declaring the locomotive as unavailable for performing any mission.

In operation, it is contemplated that a system embodying aspects of the present invention may be utilized for generating and reporting messages addressing any combination of the following exemplary functions:

1. Targeted Reporting
a. Asset Operation
   i. Monitoring engineer/operator performance and alerting operators, dispatchers, and supervisors of abnormal/undesired events regarding the operation of a railroad asset—e.g., excessive power braking, stalls, mainline stops, and disablement of energy savings systems
   ii. Reporting condition of railroad asset and performance to dispatch, maintenance and/or control systems—e.g. the message frequency and content may be varied as a function of criticality of the condition of the asset, criticality of mission completion, etc.
b. Cost effective Utilization of Asset
   i. For example, calculating and reporting information that may determine cost-effective utilization of a railroad asset, such as down time of the asset due to repairs, fuel consumption, fuel purchases and emission output relative to any desired reference standard, e.g., geographic region or operating rail road. This information may be stored to develop and/or update historical databases
c. Security/Safety Issues
   i. Monitoring events regarding a railroad asset that may require urgent reporting. For example, combined or individual monitoring of locomotive and wayside equipment may be used for promptly alerting operators, dispatchers, and supervisors of unusual and/or undesirable events—e.g., train over-speed, emergency brake applications, substantial wheel slide, failure to activate horns at crossings, operator's failure to respond to alerts, presence of hazardous cargo, etc.

2. Configurable Reporting System—Configurable parameters for determining the extent and scope of reporting (e.g., geo-boundaries, threshold levels for reporting, alert distributions). This may be carried out at both on-board and off-board processing systems

3. Intelligent Reporting System—This would allow for developing learning strategies for more effective data collection, processing, and/or reporting at both on-board and off-board segments—can use transfer functions, learning systems, and fuzzy logic

The foregoing reporting techniques can be applied at various levels such as within a given railroad enterprise (e.g., regional dispatch), across multiple railroad enterprises (e.g., billing for locomotive usage, interchange notifications), and across an entire transportation network (e.g., notify shippers of freight arrivals). Accordingly, the expression “railroad transportation network” should be broadly construed since such expression is meant to encompass any combination of the foregoing exemplary applications.

Aspects of the present invention can also be embodied as computer readable code on a computer readable medium. The computer readable medium may be any data storage device that can store data, which thereafter can be read by a computer system. Examples of computer readable medium include read-only memory, random-access memory, CD-ROMs, DVDs, magnetic tape, optical data storage devices. The computer readable medium may also be distributed over network coupled computer systems so that the computer readable code is stored and executed in a distributed fashion.

Based on the foregoing specification, aspects of the present invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to aspects of the invention. The computer readable media may be, for example, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention as set forth in the claims.

User interface may be provided by way of keyboard, mouse, pen, voice, touch screen, or any other means by which a human can interface with a computer, including through other programs such as application programs.

One skilled in the art of computer science will easily be able to combine the software created as described with appropriate general purpose or special purpose computer hardware to create a computer system or computer sub-system embodying aspects of the invention.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A method for reporting and processing information relating to railroad assets to user entities that form part of a railroad transportation network, said entities comprising a plurality of entity groups performing distinct functions relative to the railroad assets in forming, operating, maintaining and/or servicing the assets of the railroad transportation network, said method comprising:
identifying at least two entity groups having a distinct function relative to the railroad assets;
monitoring a condition associated with a railroad asset;
generating data indicative of said condition of the railroad asset;
providing rules for associating with each identified entity group a unique set of informational characteristics of interest to each identified entity group regarding the condition for the railroad asset, with said unique set of informational characteristics being based, at least in part, on the distinct functions performed by said entity group;
processing the data relative to the rules to generate a message with the unique set of informational characteristics for each respective group regarding the condition associated with the railroad asset; and
communicating the generated messages to the respective groups, thereby tailoring and communicating data for each entity group based on the distinct functions performed by said entity groups.

2. The method for reporting and processing information of claim 1 wherein the data comprises diagnostics knowledge data gathered from a plurality of assets having undergone diagnostics and found to be affected by a same type of occurrence.

3. The method for reporting and processing information of claim 2 wherein a message generated based on said diagnostics knowledge data is adapted to reconfigure a diagnostics output for a railroad asset comprising at least one locomotive of a class similarly affected as a plurality of locomotives regarding a respective piece of equipment.

4. The method for reporting and processing information of claim 2 wherein, based on the reconfigured diagnostics output, adjusting the unique set of informational characteristics to be communicated to each respective group regarding the condition indicated by the monitored data for said piece of equipment.

5. The method for reporting and processing information of claim 1 wherein the plurality of said entity groups is selected from the group consisting of a dispatcher system, a maintenance system, a user interface for a locomotive operator, a user interface for performing accounting operations, a diagnostics system, and at least one locomotive in said railroad transportation network.

6. The method for reporting and processing information of claim 1 wherein an asset of the railroad transportation network whose condition is being monitored is selected from the group consisting of at least one locomotive, equipment onboard a locomotive, wayside equipment, railcar equipment, railway tracks and any combination of said assets.

7. The method for reporting and processing information of claim 6 wherein the monitored condition comprises environmental and/or operational conditions associated with any of the foregoing assets.

8. The method for reporting and processing information of claim 1 further comprising calculating a parameter indicative of a time-varying health condition for a given piece of equipment onboard a locomotive, and, based on the value of the parameter indicative of the time-varying health condition relative to a predefined health condition threshold for said piece of equipment, adjusting the unique set of informational characteristics to be communicated to each respective group regarding the condition indicated by the monitored data for said piece of equipment

9. The method for reporting and processing information of claim 1 further comprising defining a transfer function for calculating a parameter indicative of a time-varying health condition for a respective system onboard a locomotive, said transfer function configured to determine an individual effect of each component that comprises said system on the parameter indicative of the time-varying health condition for said system.

10. The method for reporting and processing information of claim 9 further comprising, based on the value of the parameter indicative of the time-varying health condition for the respective system relative to a predefined health condition threshold for said system, adjusting the informational detail to each respective group regarding the condition indicated by the monitored data for said system.

11. The method for reporting and processing information of claim 1 wherein the unique set of informational characteristics for the message to be communicated to each respective group regarding the condition associated with the asset of the railroad transportation network is selected from the group consisting of message format and message content, and a combination of said characteristics.

12. A system for reporting and processing information relating to railroad assets to user entities that form part of a railroad transportation network, said entities comprising a plurality of entity groups performing distinct functions relative to the railroad assets in forming, operating, maintaining and/or servicing the assets of the railroad transportation network, said system comprising:
a module for identifying at least two entity groups having a distinct function relative to the railroad assets;
a monitor for monitoring a condition associated with a railroad asset, said monitor being configured to generate data indicative of said condition of the railroad asset;
a memory device including rules for associating with each identified entity group a unique set of informational characteristics of interest to each identified entity group regarding the condition for the railroad asset, with said unique set of informational characteristics being based, at least in part, on the distinct functions performed by said entity group;
a processor configured to process the data relative to the rules to generate a message with the unique set of informational characteristics for each respective group regarding the condition associated with the railroad asset; and
a transmitter for communicating the generated messages to the respective groups, thereby tailoring and communicating data for each entity group based on the distinct functions performed by said entity groups.

13. The system for reporting and processing information of claim 12 wherein the data comprises diagnostics knowledge data gathered from a plurality of assets having undergone diagnostics and found to be affected by a same type of occurrence.

14. The system for reporting and processing information of claim 13 wherein a message generated based on said diagnostics knowledge data is adapted to reconfigure a diagnostics output in a railroad asset comprising at least one locomotive of a class similarly affected as a plurality of locomotives regarding a respective piece of equipment.

15. The system for reporting and processing information of claim 14 further comprising a module responsive to the reconfigured diagnostics output so as to adjust the unique set of informational characteristics to be communicated to each respective group regarding the condition indicated by the monitored data for said piece of equipment.

16. The system for reporting and processing information of claim 12 wherein the plurality of said entity groups is selected from the group consisting of a dispatcher system, a maintenance system, a user interface for a locomotive operator, a user interface for performing accounting operations, a diagnostics system, and at least one locomotive in said railroad transportation network.

17. The system for reporting and processing information of claim 12 wherein an asset of the railroad transportation network whose condition is being monitored is selected from the group consisting of at least one locomotive, equipment onboard a locomotive, wayside equipment, train cart equipment, railway tracks and any combination of said assets.

18. The system for reporting and processing information of claim 17 wherein the monitored condition comprises environmental and/or operational conditions associated with any of the foregoing assets.

19. The system for reporting and processing information of claim 12 further comprising a first module configured to calculate a parameter indicative of a time-varying health condition for a given piece of equipment onboard a locomotive, and, a second module responsive to the value of the parameter indicative of the time-varying health condition relative to a predefined health condition threshold for said piece of equipment so as to adjust the unique set of informational characteristics to be communicated to each respective group regarding the condition indicated by the monitored data for said piece of equipment

20. The system for reporting and processing information of claim 12 further comprising a module for defining a transfer function configured to calculate a parameter indicative of a time-varying health condition for a respective system onboard a locomotive, said transfer function configured to determine an individual effect of each component that comprises said system on the parameter indicative of the time-varying health condition for said system.

21. The system for reporting and processing information of claim 20 further comprising a module responsive to the value of the parameter indicative of the time-varying health condition for the respective system relative to a predefined health condition threshold for said system so as to adjust the informational detail to each respective group regarding the condition indicated by the monitored data for said system.

22. The system for reporting and processing information of claim 12 wherein the unique set of informational characteristics for the message to be communicated to each respective group regarding the condition associated with the asset of the railroad transportation network is selected from the group consisting of message format and message content, and a combination of said characteristics.

23. A computer program product comprising a computer-usable medium having a computer-readable code therein for reporting and processing information relating to railroad assets to user entities that form part of a railroad transportation network, said entities comprising a plurality of entity groups performing distinct functions relative to the railroad assets in forming, operating, maintaining and/or servicing the assets of the railroad transportation network, the computer program product comprising:
computer-readable code for identifying at least two entity groups having a distinct function relative to the railroad assets;
computer-readable code for monitoring data indicative of a condition of the railroad asset;
computer-readable code comprising rules for associating with each identified entity group a unique set of informational characteristics of interest to each identified entity group regarding the condition for the railroad asset, with said unique set of informational characteristics being based, at least in part, on the distinct functions performed by said entity group;
computer-readable code for processing the data relative to the rules to generate a message with the unique set of informational characteristics for each respective group regarding the condition associated with the railroad asset; and
computer-readable code for communicating the generated messages to the respective groups, thereby tailoring and communicating data for each entity group based on the distinct functions performed by said entity groups.

24. The computer program product for reporting and processing information of claim 23 wherein the data comprises diagnostics knowledge data gathered from a plurality of assets having undergone diagnostics and found to be affected by a same type of occurrence.

25. The computer program product for reporting and processing information of claim 24 wherein a message generated based on said diagnostics knowledge data is adapted to reconfigure a diagnostics output for a railroad asset comprising at least one locomotive of a class similarly affected as a plurality of locomotives regarding a respective piece of equipment.

26. The computer program product for reporting and processing information of claim 24 further comprising computer-readable code for adjusting, based on a reconfigured diagnostics output, the unique set of informational characteristics to be communicated to each respective group regarding the condition indicated by the monitored data for said piece of equipment.

27. The computer program product for reporting and processing information of claim 23 wherein the plurality of said entity groups is selected from the group consisting of a dispatcher system, a maintenance system, a user interface for a locomotive operator, a user interface for performing accounting operations, a diagnostics system, and at least one locomotive in said railroad transportation network.

28. The computer program product for reporting and processing information of claim 23 wherein an asset of the railroad transportation network whose condition is being monitored is selected from the group consisting of at least one locomotive, equipment onboard a locomotive, wayside equipment, railcar equipment, railway tracks and any combination of said assets.

29. The computer program product for reporting and processing information of claim 28 wherein the monitored data comprises data indicative of environmental and/or operational conditions associated with any of the foregoing assets.

30. The computer program product for reporting and processing information of claim 23 further comprising computer-readable code for calculating a parameter indicative of a time-varying health condition for a given piece of equipment onboard a locomotive, said computer-readable code, based on the value of the parameter indicative of the time-varying health condition relative to a health condition threshold for said piece of equipment, adjusting the unique set of informational characteristics to be communicated to each respective group regarding the condition indicated by the monitored data for said piece of equipment

31. The computer program product for reporting and processing information of claim 23 further comprising computer-readable code defining a transfer function for calculating a parameter indicative of a time-varying health condition for a respective system onboard a locomotive, said transfer function configured to determine an individual effect of each component that comprises said system on the parameter indicative of the time-varying health condition for said system.

32. The computer program product for reporting and processing information of claim 31 further comprising computer-readable code, responsive to the value of the parameter indicative of the time-varying health condition for the respective system relative to a health condition threshold for said system, for adjusting the informational detail to each respective group regarding the condition indicated by the monitored data for said system.

33. The computer program product for reporting and processing information of claim 23 wherein the unique set of informational characteristics for the message to be communicated to each respective group regarding the condition associated with the asset of the railroad transportation network is selected from the group consisting of message format and message content, and a combination of said characteristics.
